(19) United States
(12) Patent Application Publication
(10) Pub. No.: US 2008/0319115 A1
(43) Pub. Date: Dec. 25, 2008

(54) Surface-Modified Inorganic Fillers and Pigments (II)

(75) Inventor: Dieter Munchow, Cologne (DE)

Correspondence Address: HARNESS, DICKEY & PIERCE, P.L.C., P.O. BOX 828, BLOOMFIELD HILLS, MI, 48303, US

(73) Assignee: ALPHA CALCIT FUELLSTOFF GESELLSCHAFT MBH, Cologne (DE)

(21) Appl. No.: 12/091,530

(22) PCT Filed: Oct. 27, 2006
(86) PCT No.: PCT/EP2006/067886

§ 371 Date: May 23, 2008

(30) Foreign Application Priority Data
Nov. 4, 2005 (EP) PCT/EP2005/055771

(51) Int. Cl. C08K 3/26; C08K 3/34; C08K 3/20; C08K 3/22; C08K 3/30; C08K 11/00

(52) U.S. Cl. 524/421; 524/425; 524/447; 524/444; 524/438; 524/424; 524/449; 524/436; 524/456; 524/442

(57) ABSTRACT

The invention relates to a process for the preparation of surface-modified inorganic fillers or pigments of a defined grain size, characterized in that filler or pigment slurries of inorganic fillers or pigments having a defined grain size are milled with the action of pressure and/or shear forces using polymer dispersions.

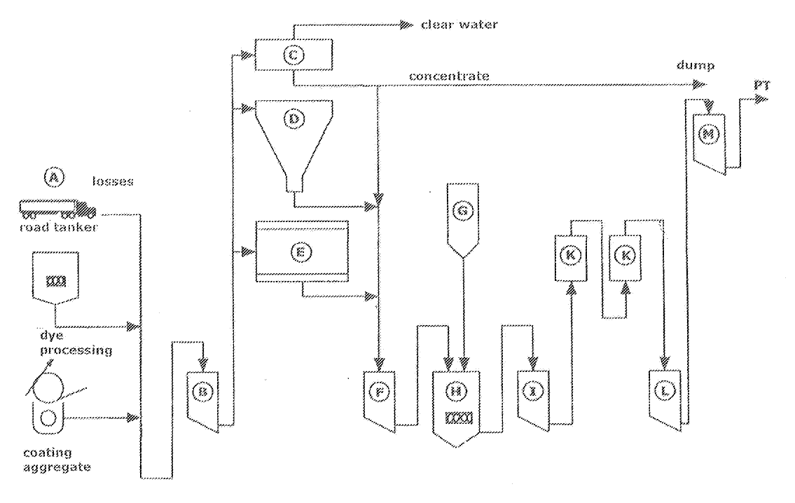

### FIELD

The invention relates to a process for the preparation of surface-modified inorganic fillers and pigments of a defined grain size, the thus obtained fillers and pigments, and the use thereof.

### BACKGROUND

In many fields of technology, inorganic pigments or fillers are bound with binders in the form of polymer dispersions, for example, in the preparation of dispersion paints, adhesives, coatings or paper.

EP 0 515 928 B1 relates to surface-modified platelet-like pigments with improved repulping behavior, and a process for the preparation thereof, and the use thereof. Said platelet-like pigments, for example, platelet-like metals, metal oxides, mica pigments and other platelet-like substrates, are coated with a polyacrylate or polymethacrylate or their water-soluble salts and optionally a solvent or mixture of solvents in a mixing vessel with stirring.

For example, in the preparation of paper, a large amount of fillers is employed. Almost all papers are admixed with fillers, which provide a uniform formation, better softness, whiteness and grip to printing and writing papers, in particular.

Natural printing papers (uncoated papers) contain up to 35% by weight of fillers, coated papers contain from 25 to 50% by weight of fillers. The amount of fillers is highly dependent on the intended use of the paper. Heavily loaded papers have lower strengths and a poorer sizing capability.

The filler content in the paper composition is usually from 5 to 35% by weight and consists of primary pigments or recirculated coating pigments which may be derived from residual coats or coated rejects. In addition to the whiteness of the filler, which is important for fluorescent whitened paper, the grain size plays an important role, because it highly influences the filler yield and the physical properties of the paper, especially its porosity. The filler content remaining in the paper is from 20 to 80% by weight of the amount added to the fiber suspension. The yield depends on both the type of filler and the composition of matter, the degree of milling, the fixing of the filler particles by resin and aluminum sulfate, the basis weight, the speed of the paper machine, the way of water withdrawal, and the fineness of the screen.

As judged by their consumption, the following products have rather great importance today as fillers and coating pigments: china clay, calcium carbonate, artificial aluminum silicates and oxide hydrates, titanium dioxide, satin white, talcum and calcium silicate.

EP 0 595 723 B1 describes a process for the preparation of mineral-based loading pigments, characterized in that a co-milling of a compacting mineral, a lamellar mineral and/or a plastic pigment in performed in aqueous medium in the presence of at least one milling aid comprising at least one dispersing agent. However, this document remains too vague with respect to the conditions in the co-milling of mineral and plastic pigment and fails to mention the use of dispersing agents.

WO 98/01621 describes a process for the reuse of fillers and coating pigments from the preparation of paper, paperboard and cardboard from the residual water sludges from coating plant waste waters, deinking plants, internal water treatment plants or separators, and the use of a thus obtained pigment slurry for the preparation of a coating composition for the paper industry, or for use in the paper stock for papermaking. An essential element of the invention is a process for reusing fillers and coating pigments from the preparation of paper, paperboard and cardboard from the residual water sludges from coating plant waste waters, deinking plants, internal water treatment plants or separators which is characterized in that said residual water sludges containing fillers and coating pigments are subjected to mixing and subsequently milling to form a pigment slurry with fresh pigment or fresh filler as powders, slurry containing fresh pigment and/or slurry containing fresh filler.

DE 43 12 463 C1 relates to a CaCO₃-talcum coating pigment slurry containing a CaCO₃-talcum pigment mixture, water and milling aids, characterized by consisting of the following four co-milled components:

a. 24-64% by weight of CaCO₃;

b. 5-48% by weight of talcum;

c. 20-40% by weight of H₂O; and

d. a combination of auxiliary agents consisting of:

0.05-1.4% by weight of commercially available milling aids; and

0.05-1.2% by weight of commercially available dispersing agents;

and in that said pigment mixture has an average statistic particle diameter of from 0.4 μm to 1.5 μm. According to DE 43 12 463 C1, said milling aids and dispersing agents may be water-soluble polymers or copolymers, for example, Na—Ca salts of a polyacrylic acid as milling aids or the K salt of a copolymer of acrylate and butyl acrylate as a dispersing agent. The patent specification does not describe the addition of a polymer dispersion as a binder or, in particular, milling conditions leading to a polymer coating of the milled product.

U.S. Pat. No. 5,910,214 discloses a process for the preparation of calcium carbonate pigment having an average particle size of 0.3±0.1 μm, wherein a calcium carbonate slurry is milled in a wet state using 0.5-1.0 parts by weight of a dispersing agent. Said dispersing agent may contain, for example, sodium polyacrylate as a milling aid and a sodium salt of a copolymer of acrylic acid and maleic acid. The patent specification does not describe the addition of a polymer dispersion as a binder or, in particular, milling conditions leading to a polymer coating of the milled product.

EP-A-0 855 420 describes a surface-modified calcium carbonate for synthetic paper which is prepared by the wet milling of calcium carbonate particles in an aqueous medium in the presence of 0.05 to 2.0 parts by weight of a dispersing agent and milling balls, followed by treating the thus milled product in an aqueous medium with a poly(ethylene ether sulfonate) (Production Example 5). The particles are not cover-milled with a polymer dispersion and dispersing agents.

DE-A-102 09 448 discloses aqueous slurries of finely divided fillers as an additive to paper pulp that are at least partially coated or impregnated with polymers, characterized by being obtainable by treating aqueous slurries of finely divided fillers with at least one binder for paper coats (claims 1, 8).

Preferably, aqueous slurries of precipitated calcium carbonate are prepared that is free from dispersing agents and of milled calcium carbonate and obtainable by the milling of pieces of calcium carbonate or marble in the presence of anionic polymeric dispersing agents ([0026]).

The Examples describe how premilled precipitated CaCO₃ is treated with binders such as Acronal® and Styronal® (also preferred in the application as a polymer dispersion).

Example 5 [0037] mainly describes how an aqueous slurry is prepared by stirring (Heiltof stirrer at 1000 rpm) finely divided CaCO₃ in the presence of a styrene-acrylate dispersion (Acronal, based on styrene/acrylic acid) [process step (a)]. The CaCO₃ employed was merely milled first in the presence of a dispersing agent and added to the polymer dispersion.

DE-A-198 21 089 relates to a process for the preparation of aqueous slurries of finely divided fillers that are at least partially coated with polymers for the preparation of filler-containing papers, wherein an aqueous slurry of fillers is mixed with 0.05 to 5% by weight, based on the fillers, of at least one polymer glue in the form of an aqueous dispersion in the absence of cationic strengthening agents for paper (claim 1).

As a polymer glue, there are employed, for example, aqueous dispersions obtainable by the polymerization of (a) styrene, acrylonitrile and/or methacrylonitrile, (b) acrylate and/or methacrylate esters of C₁₋₁₈ alcohols and/or vinyl esters of saturated C₂₋₄ carboxylic acids and optionally (c) other monoethylenically unsaturated monomers in aqueous solution in the presence of cationic and/or amphoteric protective colloids (column 2).

In Example 2, for example, an aqueous slurry of premilled marble is dispersed by means of low molecular weight polyacrylic acid. The dispersion obtained was subsequently treated with 0.5% of a polymer glue added to the slurry in the form of a polymer dispersion 1.

EP-A-0 445 953 claims a process for the preparation of a papermaking filler material surface treated with a cationic polymer, wherein the cationic polymer according to the formula is added to a filler slurry (claim 4).

WO 2004/026973 A1 describes a process for the milling of inorganic filler particles, for example, calcium carbonate or china clay, in an aqueous medium, characterized in that said aqueous medium contains a small amount (0.05-0.25% by weight) of dispersing agent for the filler. A combination of a polyacrylate as a dispersant and a polymetaphosphate as a milling aid, for example, is mentioned as the dispersing agent. This international patent application does not describe the addition of a polymer dispersion as a binder or, in particular, milling conditions leading to a polymer coating of the milled product.

### SUMMARY

The object of the present invention is to improve the contact of inorganic fillers and pigments and binders in the form of polymer dispersions and thus to reduce the necessary amount of binders or to improve the binding of the fillers or pigments to one another and to the substrate, for the preparation of filler or pigment slurries, especially in the paper industry and further fields of application, such as the paint industry or adhesive industry.

### DETAILED DESCRIPTION

According to the invention, it has been found that inorganic pigments of a defined grain size whose surface is coated with binders during milling, referred to as polymer dispersions in the following, at an elevated temperature can be advantageously employed in many fields of technology, for example, in paper industry and paint industry or adhesive industry.

Accordingly, a first embodiment of the present invention is a process for the preparation of surface-modified inorganic fillers or pigments of a desired grain size, characterized in that filler or pigment slurries of inorganic fillers or pigments having a defined grain size are milled with the action of pressure and shear forces using

(a) polymer dispersions

(b) per se known milling aids and/or dispersing agents in an amount of from 0.1 to 4.0% by weight (active substance), based on the fillers or pigments, and

(c) milling balls having an equivalent diameter of up to 5 mm

in a vertical mill at a temperature of the milling product of at least 50° C. to the desired grain size of said fillers or pigments, the binders of the polymer dispersion are rubbed onto the fillers or pigments while providing them with a polymer coating.

Due to the use of a vertical ball mill and the fact that the milling product is milled at temperatures of above 50° C., especially above 55° C. or preferably essentially within a range of from 60 to 90° C., a substantially uniform polymer coating with the added binder is achieved in an optimum way with milling balls having an equivalent diameter of up to 5 mm.

It has been found that polymer dispersions, which usually should have an adhesive effect, are suitable for providing inorganic fillers and pigments in a form which provides an increased binding capability as compared to fillers and pigments of the same grain size distribution known from the prior art if binders are contacted with surfaces of inorganic fillers and pigments during the milling of said fillers and pigments to give the desired grain size. The binders may be derived from materials to be reused, for example, residual water sludges, or they may be added directly.

Surprisingly, it has been found that the polymer particles do not lead to agglutination or agglomeration of the filler particles and pigment particles, but evidently form a fine film on the surface of the fillers or pigments which have a very much improved adhesion to one another and to the substrate, for example, fibers, in the paper industry.

A particularly preferred filler or pigment for modification within the meaning of the present invention is calcium carbonate, especially natural and/or precipitated calcium carbonate.

Apart from calcium carbonate, other fillers and pigments known in the prior art may be employed, such as china clay, artificial and/or natural aluminum silicates and oxide hydrates, titanium dioxide, satin white, dolomite, mica, metal flakes, especially aluminum flakes, bentonite, rutile, magnesium hydroxide, gypsum, sheet silicates, talcum, calcium silicate and other rocks and earths.

According to the present invention, it is particularly preferred to employ the above defined fillers and pigments in an amount of from 10 to 90% by weight, especially from 30 to 70% by weight, based on the slurry, especially water.

When the fillers or pigments are applied, for example, as components of the coat in paper making, usually a high proportion of the binder migrates into the paper surface. A large proportion of the binder is absorbed in the raw paper before film formation occurs. The uppermost coating layer becomes deficient in binders, and the so-called pulling occurs. However, if the polymer binder is milled onto the filler or pigment, the migration of the binder does not occur, or only so to a small extent; i.e., the offset strength (resistance to pulling) is higher because no (or little) binder is lost by absorption. In contrast, in the prior art, the loss of binder must be compensated for by an increased binder proportion in the coat.

Polymer dispersions within the meaning of the present invention comprise the resin solids per se and their dispersions (latices) of finely dispersed natural and/or synthetic polymers, especially in a particles size of from 0.005 to 6 μm, especially from 0.05 to 6 μm. Usually, these are in the form of aqueous or, less frequently, non-aqueous dispersing agents. These include dispersions of polymers, such as natural rubber (latex) and synthetic rubber (latex) as well as artificial resins (artificial resin dispersions) and plastic materials (plastics dispersions), such as polymerizates, polycondensates and polyaddition compounds, especially based on polyurethane, styrene/butadiene, styrene/acrylic acid or acrylate ester, styrene/butadiene/acrylic acid or acrylate ester, as well as vinyl acetate/acrylic acid or acrylate ester as well as suspensions containing acrylonitrile.

Under the product designations Basonal®, Acronal® and Styronal®, corresponding polymer dispersions are commercially available as binders for the dispersion paint industry and also for paper and cardboard coating. In the prior art, these polymer dispersions are incorporated into the filler or pigment slurries, which are usually adjusted to be neutral to alkaline, without a larger amount of shear by stirring, without a change of the grain size of the filler particles or pigment particles occurring. However, according to the present invention, these are directly contacted with the inorganic fillers and pigments by the action of pressure and shear forces. Of course, the same applies to the preparation of filler or pigment slurries, such as in the preparation of adhesives, in which no water is added separately. Under the action of pressure and shear forces during milling, surface-modified inorganic fillers and pigments are obtained which exhibit an improved binding activity as compared to the prior art. According to the present invention, it is particularly advantageous to mill the inorganic fillers or pigments wet in the presence of the polymer dispersions to the desired grain size. Thus, it is possible to provide a great variation of the whiteness and size distribution of the fillers or pigments for white fillers or pigments, and such variation can be controlled, in particular, by the way and duration of milling.

The amount of polymer dispersions which is contacted with the inorganic fillers or pigments is of some importance. Thus, according to the present invention, it is particularly preferred to contact said inorganic fillers or pigments with an amount of from 0.1 to 50%, especially from 5 to 15%, by weight of polymer dispersion (solids), based on the amount of pigment. The polymer dispersions are usually in an aqueous or non-aqueous form with a solids content of from 40 to 60% by weight, especially 50% by weight.

In addition to the polymer dispersions, according to the present invention, the inorganic fillers or pigments are further contacted with per se known dispersing agents or milling aids, especially polyacrylates. Such polyacrylates are described, for example, in the initially mentioned EP 0 515 928 B1, which is included herein by reference.

According to the present invention, the fillers or pigments are contacted with the above mentioned dispersing agent active ingredient in an amount of from 0.20 to 0.45%, more preferably from 0.25 to 0.4%, by weight, based on the solids content.

In the residual water sludges from coating plant waste waters of the paper and deinking plants, internal water treatment plants or separators, the fillers and coating pigments are frequently in an agglomerated form and with lower whiteness, which limits or even precludes a direct reuse in raw material processing, especially in paper coating.

By means of the present invention of the above described process, even when residual water sludges are employed, a defined concentrated pigment slurry or filler slurry is obtained which may be employed, for example, in the preparation of paper, paperboard and cardboard or paint and adhesive industries.

In papermaking, it is usual to employ the fillers and coating pigments either as powders or in the form of concentrated slurries with a solids content of from 50 to 80% by weight. Those fillers and pigments are usually supplied by the manufacturers with the desired whiteness and grain size distribution. Now, an essential element of the present invention resides in the use of the inorganic fillers and pigments in a kind of “basic grade”, preferably as a solid or as a highly concentrated slurry, with a solids content of, for example, from 70% by weight to 85% by weight or more, and an average grain diameter of, for example, from 50% less than 1 μm to 50% less than 15 μm, especially from 50% less than 3 μm to 50% less than 8 μm, and milling in the absence of the polymer dispersion, especially in an aqueous phase, to obtain the desired grain size. Thus, in the paper industry, fresh-pigment containing slurries and/or fresh-filler containing slurries can be milled to the desired whiteness and fineness by mixing and then milling together with fresh pigments or fresh fillers in the form of powders, and then used as a filler or coating pigment. The mineral fillers and pigments mentioned are usually milled to give the desired grain size in a wet or dry milling method. In wet milling, some proportion of water is inherently required. Part or all of the water necessary for the milling of the inorganic pigments can be replaced by the residual water sludges. Agglomerates of the fillers or pigments usually present in the residual water sludges do not interfere, or only little so, since they are comminuted to the desired grain sizes in the course of the wet milling process.

The pigment and filler particles of the residual water sludge which are designated for use as fillers or pigments act as milling aids and dispersing aids to disrupt the agglomerates in the milling process. At the same time, the residual water sludge including the loaded particle acts as a dispersing aid and milling aid for the fillers and pigments in the milling process so that the otherwise usual amounts of binders, dispersing aids and milling aids can be reduced according to the invention.

Accordingly, it is particularly preferred according to the invention to adjust the residual water sludge to a solids concentration of from 0.02% by weight to 60% by weight, especially from 1% by weight to 30% by weight, for said mixing and then milling together with the polymer dispersion and fresh pigments or fresh fillers in the form of powders, fresh-pigment containing slurries and/or fresh-filler containing slurries. When the concentration is too low, the recycling process becomes uneconomical.

The ratio of fillers and/or pigments to fibers in the residual water sludges of the paper industry may vary widely. It is particularly preferred according to the present invention to use residual water sludges with an optionally increased concentration of fillers and/or pigments which is in the range of from 1% by weight to 80% by weight, especially from 20% by weight to 60% by weight, based on the solids content. Thus, both the fiber content and the content of fillers and/or pigments may vary, for example, from 2 to 98% by weight, or from 98 to 2% by weight. Of course, residual water sludges free of fibers can also be employed in the paper industry according to the invention.

By way of example, the preferred compositions of various residual or waste water sludges are set forth below. Preferably, the waste water from the production comprises from 0.5 to 5% by weight, especially 2.5% by weight, of lost substances at a special fresh water requirement of from 10 to 100 l/kg, especially 20 l/kg. The concentration of the residual water sludges is preferably from 0.02 to 5.0%, especially 1.5% by weight. Particularly preferred according to the invention is a ratio of fiber content to filler and/or pigment content of 20:80 (w/w) or 80:20 (w/w), especially a ratio of fibers to pigments of 40:60 (w/w) in a waste water from paper production.

Preferably, the process according to the invention is characterized in that a coating pigment slurry or a residual water sludge containing a filler and/or coating pigment having a solids concentration of from 0.02 to 80% by weight, especially from 20 to 70% by weight, is employed for milling.

Preferably, a slurry having a solids content of from 10 to 95% by weight, especially from 40 to 80% by weight, is used for milling.

This permits a flexible and quick reaction to changing quality and production requirements, for example, with respect to the different papermaking raw materials for the paper stock, the fillers or pigments or slurries for precoating, top coating and single coating or pigmentation alone, and the mixing with other fillers or pigments.

According to the present invention, per se known additives, such as wetting agents, stabilizers, milling aids and dispersing aids, may be employed during the mixing and/or milling of the inorganic fillers and pigments.

The pigment slurries obtainable according to the present invention may be employed to particular advantage in the paper industry, especially for the preparation of a coat for paper coating or in the paper stock. Particularly preferred is their use for the preparation of a coating pigment slurry for offset paper. In addition, the slurries according to the invention are also suitable for the preparation of a coating compound for light-weight coated papers, especially with high coating speeds, and for the preparation of rotary offset papers, especially for the preparation of light-weight coated rotary offset papers, the coating of cardboard and special papers, such as labels, wallpapers, silicone base paper, self-copying paper, packaging paper, and for admixture with intaglio printing paper. Thus, the coating pigment slurries obtainable according to the invention may be employed, in particular, in sheet-fed offset papers, especially for sheet-fed offset single coating, sheet-fed offset double coating: sheet-fed offset precoating and sheet-fed offset top coating; in rotary offset papers, especially for LWC rotary offset single coating, rotary offset double coating: rotary offset precoating and rotary offset top coating; in intaglio printing, especially for LWC intaglio single coating, intaglio double coating: intaglio precoating and intaglio top coating; in cardboards, especially for cardboard double coating: cardboard precoating and cardboard top coating; and for flexographic printing and special papers, especially for labels and flexible packings. The fillers and pigments according to the invention may also be employed to advantage in paper for digital printing methods.

The process offers the opportunity to employ the pigment slurries prepared according to the invention without a loss in quality in the base papers, coatings and especially final qualities prepared therewith.

The present invention may also be employed, in particular, for the preparation of all kinds of adhesives or coatings. Adhesives are known to be non-metallic substances which bond together parts to be joined by adhesion and cohesiveness (cohesion). “Adhesive” is a generic term which includes other usual terms for adhesive types selected under physical or chemical aspects or aspects of processing technology, such as glue, paste, dispersion, solvent, reaction or contact adhesives. The designations of adhesives often contain additions for designating base materials (for example, starch paste, artificial resin glue, hide glue), processing conditions (for example, cold glues, hot-seal or hot-melt adhesives, joint glue), intended use (for example, paper adhesive, wood glues, metal adhesive, wallpaper paste, rubber adhesive) and form of delivery (for example, liquid adhesive, glue solution, glue powder, plate glue, glue jelly, putty, adhesive tape, adhesive film).

Adhesives are predominantly based on organic compounds, but inorganic adhesives are also employed.

DIN 16 920 standard classifies adhesive types into physically curing adhesives (glues, pastes, solvents, dispersion, plastisol and hot-melt adhesives) and chemically curing adhesives (for example, cyanoacrylate adhesives). The physically curing adhesives can be solvent-free (hot-melt adhesives) or solvent-containing. They cure by changing their state of matter (liquid→solid) or by evaporation of the solvent before or during the bonding process and are generally one-component.

The chemically curing one- or more-component reaction adhesives may be based on any polymerization reactions: two-component systems of epoxy resins and acid anhydrides or polyamines react according to polyaddition mechanisms, cyanoacrylates or methacrylates react according to polymerization mechanisms, and systems based on aminoplasts or phenoplasts react according to polycondensation mechanisms.

The range of monomers or polymers which can be employed as adhesive raw materials is widely variable and enables bondings between almost all materials. The bonding of plastic materials tends to be problematic.

The dominant object of current adhesive developments is the conversion from systems containing organic solvents to solvent-free systems or systems containing water as solvent (which is compulsory from ecological and economic points of view).

The fillers or pigments according to the invention are also suitable for the preparation of paints and lacquers. More preferably, the fillers or pigments serve for the preparation of dispersion paints and dispersion dyes. The latter term includes a group of synthetic dyes sparingly soluble in water (in most cases azo dyes or anthraquinone derivatives, also naphthol AS dyes) which are used in a very finely ground state together with dispersing agents for the dyeing and printing of acetate, polyester, polyamide, polyacrylonitrile, PVC and polyurethane fibers. During dyeing, the dye contents, which are dissolved molecularly in the dye bath, penetrate into the fiber by diffusion, where they form a solid solution and thus yield fast dyeings. A modern variant is the so-called transfer dyeing, in which dispersion dyes are transferred thermally from paper onto fabrics.

Thus, it is possible to subject relatively coarse inorganic fillers or pigments to fine milling. The user of the fillers and pigments according to the invention is not bound to particle sizes prescribed by suppliers of the raw materials. In many fields of the prior art, it is usual to characterize finished filler or pigment slurries of suppliers of raw materials by the weight percent of particles which are smaller than 2 μm, for example, as grade, fineness or type 95, 90, 75, 60, 50 etc.

In many fields of technology, the grain size distribution plays a particular role in the use of the fillers or pigments. According to the present invention, it is particularly preferred to employ fillers or pigments having a grain size distribution of from 10 to 99% by weight of particles of <10 μm, especially from 10 to 95% by weight of particles of <1 μm, respectively based on the equivalent diameter.

Particularly preferred according to the present invention are fillers or pigments with a grain size distribution of:

a) from 95 to 100% by weight of particles <20 μm; and/or

b) from 50 to 100% by weight of particles <2 μm, especially from 50 to 95% by weight of particles <2 μm; and/or

c) from 27 to 99% by weight of particles <1 μm, especially from 27 to 75% by weight of particles <1 μm; and/or

d) from 0.1 to 55% by weight of particles <0.2 μm, especially from 0.1 to 35% by weight of particles <0.2 μm;

respectively based on the equivalent diameter.

In the following, preferred fields of application for the process according to the invention and the thus obtained fillers or pigments are discussed.

Paint Industry:

The classical formulation of an interior dispersion paint usually contains a proportion of about 10% of a polymer dispersion based on styrene acrylate. A classical façade paint formulation usually has a proportion of from 18 to 25% of a polymer dispersion.

According to the invention, it has been found that the use of a filler slurry coated with a polymer dispersion can reduce the proportion of the total dispersion or the resin proportion in the final formulation while the strength of the formulation is the same as before, or that the strength is significantly increased while the resin proportion in the formulations is the same as before. Thus, in the present case, a standard formulation is adjusted by changing 50% of the binder contained in the formulation. Due to the necessity that a coated calcium carbonate slurry is taken as the basis for the experiments, by analogy, the solids content of the calcium carbonate in the standard formulation is recurred to and modified in the comparative formulation in such a way that the fillers which had previously been added dry to the dispersion are adequately replaced by the same amount of slurry calculated as solids. This has the consequence that two identical formulations are obtained with adequately identical amounts of binders and identical amounts of inorganic fillers. However, in the latter case, a proportion as described above of the previous standard formulation proportion was replaced by the coated carbonate slurry newly designed according to the invention. Thus, it was demonstrated that the strength of the paint is adequately increased as based on the washability according to DIN. The paints prepared by using the fillers or pigments according to the invention had a clearly improved resistance.

In another case, the resin content in the formulation was decreased by 20% by weight as compared to the standard formulation. The remaining 80% by weight of the resins contained in the formulation was replaced by employing, from an absolute point of view, half of this remaining 80% by weight by adding of normal standard dispersion and, in the other half, of carbonate slurry coated according to the invention in accordance with the novel process. In this case too, washability was measured as compared with the standard. The paints prepared using the fillers or pigments according to the invention had a clearly improved resistance.

Adhesive Industry

An adhesive formulation for a typical floor adhesive for bonding textile or other floors classically contains a proportion of 35% of a terpolymeric dispersion with a resin content of 50%.

In the present case, one part of the binder was replaced by one part according to the present invention, so that the total proportion of resin in the formulation remained the same as before, and also the proportion of filler in the formulation remained the same as in the standard. It should be demonstrated that the strength had clearly improved over that of the standard.

The thus prepared formulations were used by performing a bonding with a previously defined standard fitted carpeting on a solid ground and afterwards comparing what force was necessary to delaminate the layers thus bonded with one another. The adhesives prepared by using the fillers and pigments according to the invention has clearly higher delaminating forces.

Paper Industry

In the paper industry, coating paints which contain about 10% by weight of a polymer dispersion (solids) are usually used for surface coating. In the present case, the standard coating paint was based on calcium carbonate with 10% by weight of polymer dispersion (solids). As an alternative, the same formulation was prepared with the same amounts of carbonate and binder, but modifying part of the previous formulation by replacing both the binder and calcium carbonate adequately by calcium carbonate slurry coated according to the invention, wherein the same polymer dispersion which was previously merely added as a component in the formulation was used for coating. Subsequently, the pulling strength of the coating was compared, wherein in both cases a raw paper was coated with about 14 to 15 g/m² of the above mentioned formulation, either with the standard or with the alternative. The pulling strength shows which coating film is better connected with the raw paper. The pulling strength of the papers using the fillers and pigments according to the invention was clearly improved as compared to the standard fillers and pigments.

Then, with these three examples, it could be demonstrated in terms of application technology that a coating in liquid phase of the inorganic filler gives a clear improvement of the strength values of the coating over the traditional application by merely mixing dispersions and inorganic fillers.

A particularly preferred application of the present invention relates to the use of residual water sludges, especially in the paper industry.

In paper production, losses of coating paints or coating paint components occur which are from 4% by weight to 12% by weight of the material employed.

These residual coating paints or rejects are mainly obtained at position A of the Figure:

on the coating aggregates, e.g., by changing the grades, breaks, shutdown and start-up of the plant;

in the processing of coating paints, e.g., in faulty batches, filtering;

in the raw material stock, in the unloading of tank trucks, charging and discharging of containers.

Such interruptions are accompanied by cleaning works, so that the reject waters usually exhibit only low solids contents of around 1 to 2% by weight. The rejects are mostly, as in the present case example, collected without separation in a “residuals collecting container” at position B.

At this point, the paper factory can chose different routes, for example:

a) The Route to the Dump

In most cases, as in the application case described here, the rejects are flocculated, for example, by means of a centrifuge (position C) or sedimentation process (position D), dewatered and brought to maximum solids content (>55%) and “disposed of” in this form on the dump. Valuable starting materials, such as pigments and binders, are lost for the production process.

b) Recycling to the paper coating process by means of the present invention while the quality of the calcium carbonate pigment is increased. Thus, the present invention is integrated into the production cycle of the paper factory.

First, the rejects are flocculated by adding cationic products. The pigments and coagulated binder are separated from the water. Sedimentation means (position D) or decanters (position E) may serve this purpose. Also, the centrifugate from the centrifuge at position C may be used; the clear water obtained is used as production water or is supplied to the processing plant without putting a load on it.

Positions C and D are usually parts of the paper factory, and position E is a part of the present invention. In the application case described here, the concentrated reject from the factory's own sedimentation funnel is added to the milling plant. The latter is composed of the following elements:

Pos. F: Buffer container for flocculated and concentrated reject;

Pos. G: Silo for CaCO₃ powder stock;

Pos. H: Mixer for mixtures of dry CaCO₃ and reject;

Pos. I: Storage container for CaCO₃ slurry;

Pos. K: two-step ball mill;

optionally Pos. L: optionally intermediate container for ready milled CaCO₃ slurry.

The following procedure is followed, as in the application case:

Concentrated reject is collected in the buffer container F. If no reject is obtained, the container is charged with water.

In the mixer H, reject and optionally dispersing agent is charged, and then the CaCO₃ powder from silo G is dispersed at 75 to 80% by weight solids.

In the storage container I, the slurry is intermediately stored and supplied

continuously to the vertical ball mill K. In the mill, the slurry is milled to the desired fine division with the addition of milling aids with and without a polymer dispersion at a temperature of the milling product of at least 50° C. (preferably from 60 to 90° C.). For this milling, milling balls having an equivalent diameter of up to 5 mm, for example 2 mm, are employed. This calcium carbonate slurry is

intermediately stored in container L, and subsequently, after checking the particle size, solids content, viscosity and pH value, the same slurry is admixed with polymer dispersion in the coating kitchen, and the thus produced coating paint is

transported into the storage container M of the coating plant. When using a continuous operation, the containers F and I can also be dispensed with in the process according to the invention.

Further, it is essential that the slurry in the mixer H and/or in the storage container I and/or in the vertical ball mill K is admixed with binder-polymer dispersion prior to milling, or contains the binder-polymer dispersion already in the buffer container F.

When the rejects are reused according to the present invention, the pigments can be theoretically be separated off and recycled alone. However, the process according to the invention also provides for recycling of the binder, for the milling of the pigment with the binder is of critical importance to the quality of the carbonate pigment prepared. It is irrelevant whether the binder is in its original form as a finely dispersed polymer dispersion or in a flocculated, i.e., coagulated, state as a globular cluster, because the binder has its activity potential also as a coagulate. During the milling, the binder is rubbed onto the pigment particles by the mechanical attrition work between the globules of the binder, whether as individual particles or as agglomerate, and converted to a film by the high temperature. Thus, the filler or pigment particles are coated with a binder film.

Thus, this binder proportion is already firmly anchored and can no longer become absorbed in the absorptive substrate (raw paper or raw cardboard). The absorption means loss of binder or deficiency of the coat in binder, and thus, the pulling resistance and print gloss become lower, for example. The absorption can also be effected irregularly if zones with different absorptivity are present in the raw paper. This leads to a mottled printed image.

In contrast, if a filler or pigment is applied to the paper/cardboard which is already coated with binder, as in the process according to the invention, there will be no migration of this binder. The “yield” of the binder is higher; denser coats, a higher pulling resistance and a better print gloss are obtained with using less binder. When the coating pigment is distributed homogeneously, the binder is also distributed homogeneously, which leads to a uniform printing ink reception and counteracts mottle. This has been demonstrated by trials and experience with different binders in the form of both a stabilized polymer dispersion and a destabilized binder, i.e., binder agglomerates.

The performance of the process according to the invention in a usual paper factory can be described as follows:

Silos of any size desired, for example, from 50 to 1000 m³, serve to contain and store dry fillers and pigments having a uniform or optionally different basic grain size distribution, for example, calcium carbonate. Dosing devices ensure the discharging of the filler and/or pigment powder, followed by conveying, optionally to daily service tanks, optionally having purification devices. Dosing devices for the powder or powders, optionally controlled by stored-program controls (SPC) with the electronically integrated formulations, determine by gravimetry and/or volumetry the required amounts of the components to be mixed with water, fresh water or white water from the paper factory. According to the invention, a residual water sludge with a solids content of, in particular, from 0.02 to 50% by weight is employed to replace part or all of the fresh water or white water, optionally with the addition of water when the concentration of the residual water sludge is high. Accordingly, there are further required containers for storing the residual water sludge, dosing devices for the residual water sludge which determine the amount to be employed by gravimetry or volumetry. In addition, there are required containers for receiving the mixture of fresh pigment or fresh filler in the form of a powder, fresh-pigment containing and/or fresh-filler containing slurry and residual water sludge/water, optionally milling aids and dispersing aids or other auxiliaries. For dispersing and stability adjustment, dispersing means (dissolvers) or other agitators are required.

The preparation of surface-modified fillers and pigments can be performed continuously according to the invention in usual vertical agitator ball mills, for example, having a content of from 700 to 5000 l or more. Milling balls, especially having a diameter of from 1 to 4 mm, are used. Milling balls within the meaning of the invention are milling media having a basically arbitrary, but preferably essentially spheroid shape, especially (approximately) spherical milling media.

Screens, preferably sieve bends, for separating impurities (ball crushings, separating materials, rust etc.) are usually used for the processing of the residual water sludges. Laser measuring instruments serve to determine and control the milling fineness during the milling process and for the computer-based control of the agitator ball mill plant. Other dosing-injecting means for afterdosing dispersing and milling aids to the vertical agitator ball mill may also be required. After the discharge of the pigment slurry, screens for again separating off pollutants with a size of more than 20 μm may be required. Typically, the fresh pigment and/or filler material employed, especially calcium carbonate powder, has a whiteness in dry form according to DIN 53163 of more than 90%, especially a whiteness of more than 95% with a fineness of d₉₇≦25 μm, a fineness of not larger than d₉₇≦100 μm, a carbonate purity of ≧98%, an SiO₂ content of ≦1.0%, especially ≦0.2%.

Varying amounts of, for example, carbonate, mixed with polymer dispersion, are milled into a slurry having a solids content which may be adjusted, for example, to that of a ready-to-use coat. Optionally, the solids content may also be adjusted to a higher value if the pigment slurry is to be temporarily stored for an extended period of time. The fineness of the slurry is mainly determined by the dwelling time and/or the energy uptake during the production in the vertical agitator ball mill.

The whiteness of the pigment slurry depends, inter alia, on the mixing ratio of fresh pigment to water or residual water sludge, and especially on the type of fresh pigment employed.

### EXAMPLES

In a practical trial, the following examinations could be confirmed:

Paper factory with a papermaking machine and an annual production of 100,000 t of coated paper.

Papermaking machine provided with on-line coating aggregates for precoating and top coating.

Total pigment consumption of 40,000 t, including 20,000 t of CaCO₃ of a #60 fineness grade for precoating.

Reject production: 3,200 tons/year.

Capacity of the plant for performing the process according to the invention: 24 tons/day with CaCO₃ (#60 fineness*).

Object: Milling of 20 t of fine pigment with 1 t of reject for a solids content of 75% by weight.

*(#60 fineness means a proportion of 60% by weight of particles smaller than 2 μm)

The integration of the milling plant begins with the collection of the already flocculated rejects condensed to about 40% by weight in buffer container F which already contain the polymer dispersion.

In the mixer H, the reject as well as dispersant were charged, and dry CaCO₃ (30 grade) was supplied from silo G until 75% by weight of solids is achieved. The suspension obtained was pumped into storage container I, where 1.8% by weight of a commercially available milling aid (polyacrylate) was added, based on the pigment.

Now, the two-step vertical ball mills K were continuously fed from storage container I. The 30 grade CaCO₃ was milled to 60 grade CaCO₃ using essentially spherical SAZ milling balls having an equivalent diameter of from 1.6 to 2.5 mm, the milling product having a temperature of above 50° C. For the milling, 85 kW had to be used per ton. The thus prepared 60 grade slurry was stored in the intermediate container L until the particle size, viscosity, solids content and pH value were established, and then pumped into storage container M for the precoating pigment of the coating kitchen. Subsequently, this coated precoating pigment was also mixed with about 16% by weight (commercial product) of a commercially available polymer dispersion (Acronal®) to obtain a precoating paint.

In the application case described here, the precoating paint in the operational trial was composed of 60% by weight of standard 60 fineness grade carbonate plus 40% by weight of 60 fineness grade AlphaCarb®, the latter proportion of 40% by weight consisting of 15% by weight of reject and 25% by weight of 30 fineness grade CaCO₃, so that the proportion of reject in the precoating paint was at about 7% by weight of reject. At a coating speed of 820 m/min, 10-11 g/m²/side was applied on the film press in the precoating. The flowing behavior of the coating paint on the film press was unobjectionable, and the top coat was applied without streaks.

The thus coated test production was compared with standard coated paper.

Result:

As compared with coatings with the standard 60 grade pigment, coatings with the pigment according to the invention yielded:

a higher pulling resistance in an offset test of score 1 as compared to score 2;

a higher printing ink gloss of 82 as compared to 75;

a slower absorption behavior of the printing ink by about 15 s after the Prüfbau absorption test;

a better printing uniformity (evaluated visually) of score 2 as compared to score 3.

Also, in the optical and sensory testing using papers prepared by the process according to the invention, an excellent quality was established for the test papers.

Examples of the Milling of CaCO₃ with Coating Paint

For preparing a calcium carbonate pigment slurry with a fines content of more than 90% by weight of <2 μm, an aqueous anionic copolymer dispersion based on n-butyl acrylate, acrylonitrile and styrene which was free from softeners and solvents (Acronal® S360 D) in an amount of 0.25% by weight (active substance), based on the fillers and pigments, was employed in a vertical ball mill using Calcicell® 30. This polymer dispersion had a solids content of about 50% by weight and a pH value of about 8.

The quantity of calcium carbonate Calcicell® 30 in the slurry was 75% by weight. As the milling balls, SAZ balls with diameters of 1.6 to 2.5 mm were employed. The effective volume of the mill was 3 l. The power was 1.3 kW at a rotations per minute of from 400 to 1500 rpm. The temperature of the milled product during the milling was more than about 55° C.

To the calcium carbonate and water in the amounts mentioned in Table 1, a concentrated coating paint (68.7% by weight solids content) was added. To prepare the slurry, 1% by weight each of the above mentioned polymer dispersion (calculation base: filler proportion) was added to the charges.

The following Table 1 shows the experimental program:

TABLE 1

| Example | Water | | Coating paint | | Filler Calcicell ® 30 |
|---|---|---|---|---|---|
| 2 | 500 | g | 0 | g | 1500 g |
| 3 | 971 | g | 29 | g | 3000 g |
| 4 | 706.5 | g | 43.5 | g | 2250 g |
| 5 | 663 | g | 87 | g | 2010 g |
| 6 | 619.5 | g | 130.5 | g | 1890 g |
| 7 | 576 | g | 174 | g | 1320 g |

The fineness of the materials employed was determined by the laser diffraction method with a Cilas device:

Measurement of the Raw Calcium Carbonate Employed:

| D50 | 4.63 μm |
|---|---|
| D100 | 27.83 μm |
| <1 μm | 15.30% |
| <2 μm | 30.20% |

Measurement of the Coating Paint Employed:

| D50 | 1.17 μm |
|---|---|
| D100 | 9.95 μm |
| <1 μm | 41.50% |
| <2 μm | 76.10% |

### Example 2

The following analytical results were obtained with pure water:

| | |
|---|---|
| Ball volume: | 2.0 l |
| Slurry volume: | 0.9 l |

Revolutions per minute: about 1100 rpm

The samples for measuring the grain size distribution were taken after 20, 40, 60, 80, 100 and 120 min. During the milling trial, the mill was cooled with water.

TABLE 2
Evaluation of the Cilas 850/1 measurements:

| Time/min | D50/μm | D100/μm | <2 μm/% |
|---|---|---|---|
| 20 | 1.85 | 8.98 | 53.4 |
| 40 | 1.70 | 7.97 | 58.2 |
| 60 | 1.31 | 5.96 | 73.0 |
| 80 | 1.13 | 4.48 | 81.9 |
| 100 | 1.04 | 4.46 | 84.9 |
| 120 | 1.20 | 7.84 | 81.6 |

Color Values (Elrepho Measuring Device) of the Filler from the Slurry after 120 Min:

Rx=90.3/Ry=90.1/Rz=88.8/BGW=−1.7

Viscosity Measurement (Sample after 120 Min):

| | |
|---|---|
| Temperature: | 20° C. |
| Viscometer: | Brookfield HBTD |

TABLE 3
Spindle 2:

| | Speed | | |
|---|---|---|---|
| | 100 | 50 | 20 |
| Readout | 2.2 | 1.0 | 0.4 |
| Viscosity | 70.4 mPa · s | 64.0 mPa · s | 64.0 mPa · s |

### Example 3

TABLE 4
Evaluation of the Cilas 850/1 measurements:

| Time/min | D50/μm | D100/μm | <2 μm |
|---|---|---|---|
| 20 | 1.83 | 8.96 | 53.9 |
| 40 | 1.52 | 6.97 | 63.2 |
| 60 | 1.27 | 6.43 | 72.8 |
| 80 | 1.09 | 4.97 | 80.3 |
| 100 | 1.00 | 4.48 | 84.2 |
| 120 | 0.97 | 4.47 | 85.3 |
| 130 | 0.97 | 3.99 | 86.5 |
| 140 | 0.97 | 4.43 | 86.1 |

### Example 4

TABLE 5
Evaluation of the Cilas 850/1 measurements:

| Time/min | D50/μm | D100/μm | <2 μm |
|---|---|---|---|
| 20 | 1.81 | 10.0 | 54.3 |
| 40 | 1.51 | 8.0 | 64.9 |
| 60 | 1.27 | 8.0 | 75.0 |
| 80 | 1.15 | 7.0 | 80.7 |
| 100 | 1.08 | 4.96 | 84.1 |
| 110 | 1.03 | 4.48 | 85.9 |

Color Values (Elrepho Measuring Device) of the Filler from the Slurry after 110 Min:

Rx=92.2/Ry=92.0/Rz=90.7/BGW=−1.6

Viscosity Measurement (Sample after 110 Min):

| | |
|---|---|
| Temperature: | 20° C. |
| Viscometer: | Brookfield HBTD |

TABLE 6
Spindle 2:

| Speed | 100 | 50 | 20 |
|---|---|---|---|
| Readout | 2.0 | 1.1 | 0.4 |
| Viscosity | 64.0 mPa · s | 70.4 mPa · s | 64.0 mPa · s |

### Example 5

TABLE 7
Evaluation of the Cilas 850/1 measurements:

| Time/min | D50/μm | D100/μm | <2 μm |
|---|---|---|---|
| 20 | 1.94 | 9.96 | 51.1 |
| 40 | 1.53 | 7.96 | 64.2 |
| 60 | 1.32 | 6.94 | 72.7 |
| 80 | 1.20 | 7.65 | 77.5 |
| 100 | 1.08 | 4.97 | 80.6 |
| 120 | 0.99 | 3.98 | 87.6 |

Color Values (Elrepho Measuring Device) of the Filler from the Slurry after 120 Min:

Rx=92.4/Ry=92.2/Rz=90.9/BGW=−1.6

Viscosity Measurement (Sample after 120 Min):

| | |
|---|---|
| Temperature: | 20° C. |
| Viscometer: | Brookfield HBTD |

TABLE 8
Spindle 2:

| Speed | 100 | 50 | 20 |
|---|---|---|---|
| Readout | 1.7 | 0.8 | 0.3 |
| Viscosity | 54.4 mPa · s | 51.2 mPa · s | 48.0 mPa · s |

### Example 6

TABLE 9
Evaluation of the Cilas 850/1 measurements:

| Time/min | D50/μm | D100/μm | <2 μm |
|---|---|---|---|
| 20 | 1.77 | 9.96 | 55.5 |
| 40 | 1.47 | 8.91 | 65.8 |
| 60 | 1.26 | 6.95 | 74.5 |
| 80 | 1.15 | 4.98 | 80.2 |
| 100 | 1.06 | 4.96 | 84.3 |
| 120 | 1.02 | 4.92 | 86.4 |

Slight oversize on 40 μm screen, foaming, slight agglutination of the balls.

Color Values (Elrepho Measuring Device) of the Filler from the Slurry after 120 Min:

Rx=91.7/Ry=91.6/Rz=90.4/BGW=−1.4

Viscosity Measurement (Sample after 120 Min):

| | |
|---|---|
| Temperature: | 20° C. |
| Viscometer: | Brookfield HBTD |

TABLE 10
Spindle 2:

| Speed | 100 | 50 | 20 |
|---|---|---|---|
| Readout | 1.3 | 0.6 | 0.3 |
| Viscosity | 41.6 mPa · s | 38.4 mPa · s | 48.0 mPa · s |

### Example 7

TABLE 11
Evaluation of the Cilas 850/1 measurements:

| Time/min | D50/μm | D100/μm | <2 μm |
|---|---|---|---|
| 20 | 1.72 | 8.96 | 57.2 |
| 40 | 1.47 | 7.94 | 67 |
| 60 | 1.28 | 5.95 | 74.7 |
| 80 | 1.21 | 5.46 | 77.7 |
| 100 | 1.18 | 5.96 | 77.9 |
| 120 | 1.02 | 4.95 | 86.3 |

More oversize on the 40 μm screen than in Example 6. More foaming and stronger agglutination of the balls.

Color Values (Elrepho Measuring Device) of the Filler from the Slurry after 120 Min:

Rx=90.6/Ry=90.4/Rz=89.1/BGW=−1.7

Viscosity Measurement (Sample after 120 Min):

| | |
|---|---|
| Temperature: | 20° C. |
| Viscometer: | Brookfield HBTD |

TABLE 12
Spindle 2:

| Speed | 100 | 50 | 20 |
|---|---|---|---|
| Readout | 1.3 | 0.6 | 0.3 |
| Viscosity | 41.6 mPa · s | 38.4 mPa · s | 48.0 mPa · s |

TABLE 13
Evaluation of the Cilas 850/1 measurements:

| Time/min | D50/μm | D100/μm | <2 μm |
|---|---|---|---|
| 20 | 2.14 | 10.96 | 47.4 |
| 40 | 1.72 | 8.96 | 57.2 |
| 60 | 1.36 | 7.92 | 69.9 |
| 80 | 1.24 | 7.83 | 76.2 |
| 100 | 1.16 | 4.98 | 80.3 |
| 120 | 1.08 | 4.96 | 84.9 |

Color Values (Elrepho Measuring Device) of the Filler from the Slurry after 120 Min:

Rx=92.0/Ry=91.8/Rz=90.9/BGW=−1.2

Viscosity Measurement (Sample after 120 Min):

| | |
|---|---|
| Temperature: | 20° C. |
| Viscometer: | Brookfield HBTD |

TABLE 14
Spindle 2:

| Speed | 100 | 50 | 20 |
|---|---|---|---|
| Readout | 1.1 | 0.4 | 0.2 |
| Viscosity | 35.2 mPa · s | 25.6 mPa · s | 32.0 mPa · s |

### Examples 8 and 9

### Comparative Examples 1 and 2

In an experimental series for the paper industry, a comparison was made for the preparation of the paper pulp. On the one hand, a classical formulation was employed, and alternatively, the same formulation was employed, but with milling the filler with polymer binders.

In said experimental series, 100% DIP (Deinking Paper) was employed as a pulp model. The ashes content of the DIP was 0.8%. A commercially available natural calcium carbonate of a #60 fineness grade (60% of the particles are <2 μm) served as the filler. The polymer binder was a commercially available styrene acrylate. The milling was effected between calcium carbonate and a polymer binder in a vertical ball mill with milling balls made of zirconia having a diameter of about 2 mm.

The following Table illustrates the differences between the conventional process and the process according to the invention.

The differences in the experiments include the proportion of fillers (ashes) in the paper, which was 20% in one case and 30% in the other.

| Example | 8 | 9 | Comp. 1 | Comp. 2 |
|---|---|---|---|---|
| Pulp | DIP | DIP | DIP | DIP |
| Filler pigment | GCC | GCC | GCC | GCC |
| Milling with polymer | yes | yes | no | no |
| Base weight: g/m² | 110 | 120 | 110 | 120 |
| Ashes: % | 20 | 30 | 20 | 30 |
| Dry breaking length: m | 3071 | ./. | 2691 | ./. |
| Plucking resistance test: grade | 3 | 4 | 4 | 4 |
| Int. strength: J/m² | 130 | 102 | 110 | 102 |
| Porosity: ml/min | 419 | 562 | 475 | 562 |

Description of the Physical Measuring Results:

Dry breaking length in m: Dimension at which length (for example, 2691 m) a strip of paper would break under its own weight (the longer the stronger).

Plucking resistance test: Strength in Z direction; the smaller the value, the stronger.

Internal strength (“Scott bond”): Dimension in J/m² (Joule/m²); the higher the value, the better; the resistance against “delamination” is measured, so to speak.

Porosity: Air permeability in ml/min; the higher the number, the higher the porosity.

As compared to the paper with the filler not milled with polymer binder, the paper with the filler milled with the polymer binder according to the invention resulted in a clear increase of strength properties while the porosity was reduced. The fillers milled with binders supported the fiber binding in the thus equipped paper.

1. A process for the preparation of surface-modified inorganic fillers or pigments of a desired grain size, wherein filler or pigment slurries of inorganic fillers or pigments having a defined grain size are milled with the action of pressure and shear forces using
(a) polymer dispersions
(b) milling aids and/or dispersing agents having an active substance content in an amount of from 0.1 to 4.0% by weight, based on the fillers and/or pigments, and
(c) milling balls having an equivalent diameter of up to 5 mm
in a vertical mill at a temperature of the milling product of at least 50° C. to the desired grain size of said fillers or pigments, the binders of the polymer dispersion are rubbed onto the fillers or pigments while providing them with a polymer coating.

2. The process according to claim 1, wherein natural and/or precipitated calcium carbonate, china clay, artificial and/or natural aluminum silicates and oxide hydrates, titanium dioxide, satin white, dolomite, mica, metal flakes, especially aluminum flakes, bentonite, rutile, magnesium hydroxide, gypsum, sheet silicates, talcum, calcium silicate and other rocks and earths or mixtures thereof are milled as fillers or pigments.

3. The process according to claim 1, wherein filler and/or pigment slurries having a filler or pigment content of from 10 to 90% by weight, based on the slurry, are employed.

4. The process according to claim 1, wherein polymer dispersions are employed which are selected from natural and/or synthetic polymers having a particle size of from 0.005 to 6 μm in aqueous or non-aqueous phases.

5. The process according to claim 1, wherein polymer dispersions are employed which contain resins selected from natural rubber, synthetic rubber, artificial resins and plastic materials, especially based on polyurethane, styrene/butadiene, styrene/acrylic acid or acrylate ester, styrene/butadiene/acrylic acid or acrylate ester, as well as vinyl acetate/acrylic acid or acrylate ester.

6. The process according to claim 1, wherein said fillers and/or pigments are milled with polyacrylates.

7. The process according to claim 1, wherein said fillers and/or pigments are contacted with an amount of from 0.1 to 50% by weight of polymer dispersion, based on the amount of pigment.

8. The process according to claim 1, wherein said dispersing agents are contacted with the fillers and/or pigments in an amount of from 0.2 to 0.45% by weight, based on the amount of said fillers or pigments.

9. The process according to claim 1, wherein said filler and/or pigment slurries are contacted with a coating pigment slurry and/or a filler and coating pigment containing residual water sludge from coating plant waste waters, deinking plants, internal water treatment plants or separators of paper, paint, adhesive or other factories.

10-11. (canceled)

12. The process according to claim 1 for the preparation of a filler and/or pigment slurry having a solids content of from 10 to 95% by weight.

13. The process according to claim 1, wherein said fillers and/or pigments of the slurries are milled to a grain size distribution of
from 10 to 99% by weight of particles of <10 μm
based on the equivalent diameter.

14. The process according to claim 13, wherein said fillers and/or pigments of the slurries are milled to a grain size distribution of
a) from 95 to 100% by weight of particles <20 μm; and/or
b) from 50 to 100% by weight of particles <2 μm; and/or
c) from 27 to 99% by weight of particles <1 μm; and/or
d) from 0.1 to 65% by weight of particles <0.2 μm;
respectively based on the equivalent diameter.

15. Surface-modified inorganic fillers or pigments having a grain size distribution of from 50 to 95% by weight of particles of <2 μm, based on the equivalent diameter, obtainable by a process according to claim 1.

16. Use of the surface-modified fillers and/or pigments according to claim 15 for the preparation of dispersion paints, adhesives, coatings or coating compositions for the paper industry, especially of coatings or coating compositions for various segments of the paper industry, such as sheet-fed offset, rotary offset, intaglio printing, cardboard and special papers.

17. The process according to claim 1, wherein filler and/or pigment slurries having a filler or pigment content of from 30 to 70% by weight, based on the slurry, are employed.

18. The process according to claim 1, wherein fillers and/or pigments are contacted with an amount of from 5 to 15% by weight, of polymer dispersion, based on the amount of pigment.

19. The process according to claim 1, wherein said dispersing agents are contacted with the fillers and/or pigments in an amount of from 0.25 to 0.4% by weight, based on said fillers or pigments.

20. The process according to claim 1, wherein said fillers and/or pigments of the slurries are milled to a grain size distribution of from 10 to 95% by weight of particles of <1 μm, based on the equivalent diameter.

21. The process according to claim 20, wherein said fillers and/or pigments of the slurries are milled to a grain size distribution of
a) from 95 to 100% by weight of particles <20 μm; and/or
b) from 50 to 95% by weight of particles <2 μm; and/or
c) from 27 to 75% by weight of particles <1 μm; and/or
d) from 0.1 to 35% by weight of particles <0.2 μm;
respectively based on the equivalent diameter.
